(19) United States
(12) Patent Application Publication
(10) Pub. No.: US 2026/0336653 A1
(43) Pub. Date: Oct. 29, 2026

(54) INFORMATION COMMUNICATION DEVICE

(71) Applicant: SUBARU CORPORATION, Tokyo (JP)

(72) Inventors: Takanori TATEBE, Tokyo (JP); Naoto YABUKI, Tokyo (JP); Kazuki FURUKAWA, Tokyo (JP)

(21) Appl. No.: 19/119,553

(22) PCT Filed: Jul. 31, 2023
(86) PCT No.: PCT/JP2023/027929

§ 371 Date: Apr. 9, 2025

(30) Foreign Application Priority Data
Nov. 28, 2022 (JP) 2022-188852

(51) Int. Cl. B60W 50/16; B60W 50/00; G06F 3/01

(52) U.S. Cl. CPC B60W 50/16; G06F 3/016; B60W 2050/0022; B60W 2510/202; B60W 2540/18

(57) ABSTRACT

An information communication device configured to be provided in a vehicle that includes a steering device configured to steer a wheel includes a parameter detector, a vibration waveform generator, a vibrator, and a gain adjuster. The parameter detector is configured to detect a parameter that correlates with a steering amount of the steering device. The vibration waveform generator is configured to generate a vibration waveform. The vibrator is configured to cause vibration of air around an occupant with the vibration waveform. The gain adjuster is configured to increase an output gain of the vibration waveform in accordance with an increase in an absolute value of a differential value of the parameter.

### CROSS-REFERENCE TO RELATED APPLICATIONS

This application is the U.S. National Phase under 35 U.S.C. § 371 of International Application No. PCT/JP2023/027929, filed on Jul. 31, 2023, which claims the benefit of foreign priority to Japanese Patent Application No. 2022-188852 filed on Nov. 28, 2022, the entire contents of each of which are hereby incorporated by reference.

### TECHNICAL FIELD

The invention relates to an information communication device that communicates information on a behavior of a vehicle to an occupant of the vehicle.

### BACKGROUND ART

As a technique related to outputting a sound to an occupant of a vehicle such as an automobile in accordance with a state of the vehicle, for example, Patent Literature 1 discloses a driver assistance apparatus configured to easily recognize a steering angle and a steering direction. The driver assistance apparatus indicates a steering amount of a steering wheel with a sound that changes in conjunction with the steering amount.

Specifically, Patent Literature 1 discloses that the steering amount of the steering wheel is indicated by performing control that raises a musical scale as the steering amount becomes larger, or changing, for example, an intensity of the sound, a pitch of the sound, a timbre of the sound, a sound pressure of the sound, a frequency of the sound, or a position of a sound image.

Patent Literature 2 discloses a vehicle music generation apparatus that generates music reflecting a behavior of a vehicle and an operation performed by a driver in a simple way. The vehicle music generation apparatus includes a storage unit and a control unit. The storage unit holds multiple sound source loop patterns corresponding to respective pieces of information that are based on the behavior of the vehicle or the operation performed by the driver on the vehicle. The control unit selects a specified sound source loop pattern from among the multiple sound source loop patterns in accordance with the corresponding piece of information, and performs control of outputting the selected sound source loop pattern or stopping outputting the selected sound source loop pattern.

### CITATION LIST

### Patent Literature

Patent Literature 1: Japanese Unexamined Patent Application Publication No. 2007-62706
Patent Literature 2: Japanese Unexamined Patent Application Publication No. 2016-66912

### SUMMARY OF INVENTION

### Problem to be Solved by the Invention

There is a time response delay between a start of steering of a vehicle and actual occurrence of a behavior of a vehicle body that generates, for example, a lateral acceleration rate, a yaw rate, and a roll angle. Some situations of a steering operation thus may cause an occupant to feel that, for example, the lateral acceleration rate is generated abruptly and to experience discomfort or anxiety due to, for example, being unable to appropriately hold his/her body.

To address this, for example, some measures are conceivable such as lowering a yaw rate gain relative to a steering angle of the vehicle or enhancing holding performance of a seat or the like that holds the occupant.

However, the lowered yaw rate gain slows responsiveness of the vehicle to thereby impair performance and merchantability of the vehicle. Further, the measures using the seat have a difficulty in appropriately dealing with occupants of various body shapes.

In view of the above-described problems, an object of the invention is to provide an information communication device that improves predictability of an occupant for a behavior caused by steering a vehicle.

### Means for Solving the Problem

To solve the above-described problems, an aspect of the invention provides an information communication device configured to be provided in a vehicle. The vehicle includes a steering device configured to steer a wheel of the vehicle. The information communication device is characterized by including a parameter detector, a vibration waveform generator, a vibrator, and a gain adjuster. The parameter detector is configured to detect a parameter that correlates with a steering amount of the steering device. The vibration waveform generator is configured to generate a vibration waveform. The vibrator is configured to cause vibration of air around an occupant with the vibration waveform. The gain adjuster is configured to increase an output gain of the vibration waveform in accordance with an increase in an absolute value of a differential value of the parameter.

### Effects of the Invention

As described above, the invention makes it possible to provide an information communication device that improves predictability of an occupant for a behavior caused by steering a vehicle.

### BRIEF DESCRIPTION OF DRAWINGS

FIG. 1 is a diagram schematically illustrating a configuration of an electric power steering apparatus for a vehicle including an information communication device according to an embodiment of the invention.

FIG. 2 is a diagram schematically illustrating a system configuration of an information communication device according to a first embodiment.

FIG. 3(a) and 3(b) are graphs schematically illustrating examples of a vibration waveform according to the first embodiment.

FIG. 4 is a chart schematically illustrating respective timings of electrical pulses emitted by receptors upon receiving stimuli.

FIG. 5 is a diagram illustrating respective distributions of sensitivity to a frequency of Pacini's corpuscles and Meissner's corpuscles.

FIG. 6 is a graph schematically illustrating an example of gain adjustment performed by a first gain adjuster according to the first embodiment.

FIG. 7 is a graph schematically illustrating an example of an output history of a microphone according to the first embodiment.

FIG. 8 is a graph illustrating an example of a correlation between a sound pressure and a frequency of background noise according to the first embodiment.

FIG. 9 is a graph schematically illustrating an example of gain adjustment performed by a second gain adjuster according to the first embodiment.

FIG. 10 is a diagram schematically illustrating arrangement inside a vehicle compartment of a vehicle provided with the information communication device according to the first embodiment.

FIG. 11 is a diagram schematically illustrating a configuration of an automated driving system of a vehicle provided with an information communication device according to a second embodiment of the invention.

### MODES FOR CARRYING OUT THE INVENTION

### First Embodiment

In the following, an information communication device according to a first embodiment of the invention will be described.

An information communication device according to some embodiments is provided in a four-wheel vehicle (for example, an automobile such as a passenger car) that steers (turns) two front wheels, for example.

The vehicle includes an electric power steering apparatus that causes an electric motor to apply a steering assist force to a steering device that steers the front wheels.

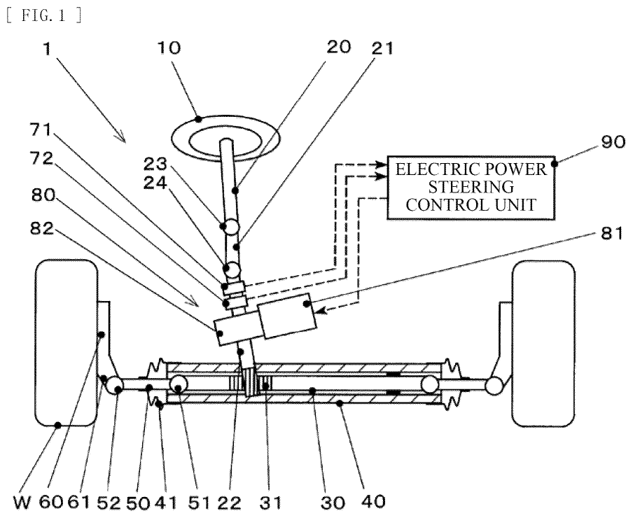

FIG. 1 is a diagram schematically illustrating a configuration of the electric power steering apparatus for the vehicle according to the first embodiment.

An electric power steering apparatus 1 includes, for example, a steering wheel 10, a steering shaft 20, an intermediate shaft 21, a pinion shaft 22, a rack shaft 30, a rack housing 40, tie rods 50, housings 60, a steering angle sensor 71, a torque sensor 72, an actuator unit 80, and an electric power steering control unit (EPS control unit) 90.

The steering wheel 10 is, for example, an annular operation member that a driver turns to input a steering operation.

The steering wheel 10 is disposed to oppose a driver's seat in a vehicle compartment of the vehicle.

An occupant (the driver) obtains a steering feeling (steering feel) of the vehicle through a sensation (a tactile sensation) communicated from the steering wheel 10 to his/her fingers.

The steering shaft 20 is a rotating shaft that has one end attached to the steering wheel 10 and that communicates a rotational motion of the steering wheel 10 to a rack-and-pinion mechanism. The rack-and-pinion mechanism converts the rotational motion into a translational motion in a vehicle width direction.

The intermediate shaft 21 and the pinion shaft 22 are sequentially coupled to an opposite end of the steering shaft 20 from the steering wheel 10.

Universal joints (cardan joints) 23 and 24 are provided respectively between the steering shaft 20 and the intermediate shaft 21 and between the intermediate shaft 21 and the pinion shaft 22. The universal joints 23 and 24 are configured to communicate rotation in a state where the respective shafts are bent.

The pinion shaft 22 has a tip including a pinion gear. The pinion gear is engaged with a rack gear 31 of the rack shaft 30 to thereby drive the rack shaft 30.

The rack shaft 30 is a columnar member disposed to cause its longitudinal direction (axial direction) to be aligned with the vehicle width direction.

The rack shaft 30 is supported to be translatable in the vehicle width direction relative to a vehicle body.

The rack shaft 30 has a part including the rack gear 31. The rack gear 31 is engaged with the pinion gear of the pinion shaft 22.

The rack gear 31 is driven by the pinion gear in response to rotation of the steering shaft 20 to thereby translate (move linearly) the rack shaft 30 in the vehicle width direction.

The rack gear 31 is disposed to be offset to one of left and right sides (usually a side of the driver's seat) in the vehicle width direction.

For example, when the vehicle is a so-called right-hand drive vehicle in which a right front seat is the driver's seat, the rack gear 31 is disposed to be offset to the right side relative to the middle in a neutral state.

The rack housing 40 is a substantially cylindrical member that houses the rack shaft 30 while supporting the rack shaft 30 in such a manner that the rack shaft 30 is relatively displaceable in the vehicle width direction.

The rack housing 40 has both ends each including a rack boot 41.

The rack boots 41 are each a member that prevents ingress of foreign matter such as dust into the rack housing 40 while allowing relative displacement of the corresponding tie rod 50 relative to the rack housing 40.

The rack boots 41 are each formed into a shape of a bellows tube having flexibility and including, for example, a resin material such as an elastomer.

The tie rods 50 are each a shaft-shaped interlocking member that couples a corresponding end of the rack shaft 30 to a knuckle arm 61 of the corresponding housing 60 and turns the housing 60 around a kingpin axis in conjunction with the translational motion of the rack shaft 30.

The tie rods 50 each have an inner end in the vehicle width direction. The inner end in the vehicle width direction is pivotally coupled to the corresponding end of the rack shaft 30 via a ball joint 51.

The tie rods 50 each have an outer end in the vehicle width direction. The outer end in the vehicle width direction is coupled to the knuckle arm 61 of the corresponding housing 60 via a ball joint 52.

The housings (knuckles) 60 are each a member that houses a hub bearing that rotatably supports a corresponding wheel W around an axle.

The housings 60 each include the knuckle arm 61 formed to protrude forward or rearward relative to the axle.

The housings 60 are each turnably supported around the kingpin axis serving as a predetermined rotational center axis.

The kingpin axis is, for example, an imaginary axis that couples a bearing center of a strut top mount to a center of a ball joint that couples a lower part of the housing 60 to a transverse link (a lower arm), when a front suspension of the vehicle is of a MacPherson strut type.

The housings 60 are each pushed and pulled by the rack shaft 30 via the corresponding tie rod 50 in the vehicle width direction to thereby turn around the kingpin axis and turn the corresponding wheel W.

The steering angle sensor 71 is an angle encoder that detects a rotational angle position of the pinion shaft 22.

An output of the steering angle sensor 71 is communicated to the electric power steering control unit 90.

The electric power steering control unit 90 is configured to calculate a steering angle (a change in a toe angle accompanied by the steering) θ of the wheels W, based on the output of the steering angle sensor 71.

The torque sensor 72 is a sensor that detects torque (mainly a force of the steering operation performed by the driver) acting on the pinion shaft 22.

The torque sensor 72 is provided on the pinion shaft 22 at a part adjacent to the intermediate shaft 21 relative to the actuator unit 80.

An output of the torque sensor 72 is communicated to the electric power steering control unit 90.

The actuator unit 80 is a drive device that rotationally drives the pinion shaft 22 to thereby provide a power assist upon manual driving and perform a steering operation upon automated driving.

The actuator unit 80 includes, for example, a motor 81 and a gearbox 82.

The motor 81 is an electric actuator that generates a driving force to be applied to the steering shaft 20.

A rotation direction and output torque of the motor 81 are controlled by the electric power steering control unit 90.

The gearbox 82 includes a reduction gear train that decelerates a rotational output (or amplifies torque) of the motor 81 to thereby communicate the decelerated rotational output (or the amplified torque) to the pinion shaft 22.

The electric power steering (EPS) control unit 90 is a control device (a motor controller) that provides the motor 81 with an electric current instruction value that controls the rotation direction and the output torque.

The electric power steering control unit 90 may include a microcontroller including, for example, an information processor such as a CPU, a storage such as a RAM or a ROM, an input/output interface, and a bus that couples these components to each other.

The electric power steering control unit 90 is configured to acquire information such as an output of the steering angle sensor 71, an output of the torque sensor 72, a travel speed (a vehicle speed) of the vehicle, or operating states of other in-vehicle electronic apparatuses directly or via an in-vehicle LAN such as a CAN communication system.

Upon manual driving of the vehicle, the electric power steering control unit 90 sets the electric current instruction value to be provided to the motor 81, based on a torque input direction and a detected torque value of the torque sensor 72.

The electric power steering control unit 90 includes a power supply device that supplies the motor 81 via a signal line with electric power having an electric current value and a voltage value that correspond to the electric current instruction value.

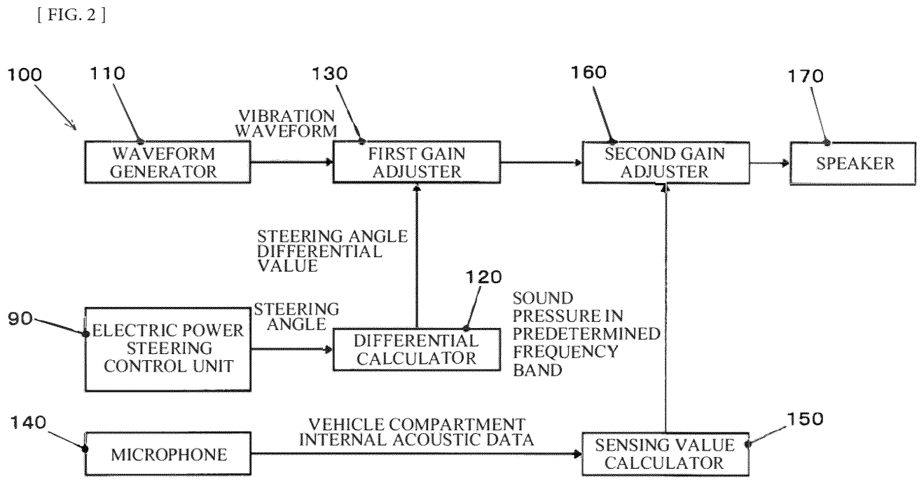

FIG. 2 is a diagram schematically illustrating a system configuration of the information communication device according to the first embodiment.

An information communication device 100 vibrates air around an ear of the occupant with a speaker 170 disposed in the vehicle compartment and notifies the occupant of a sign of occurrence of a behavior of the vehicle with an acoustic signal.

The information communication device 100 includes, for example, a waveform generator 110, a differential calculator 120, a first gain adjuster 130, a microphone 140, a sensing value calculator 150, a second gain adjuster 160, and the speaker 170.

The waveform generator 110 generates a vibration waveform that is a waveform of the acoustic signal to be generated by the speaker 170.

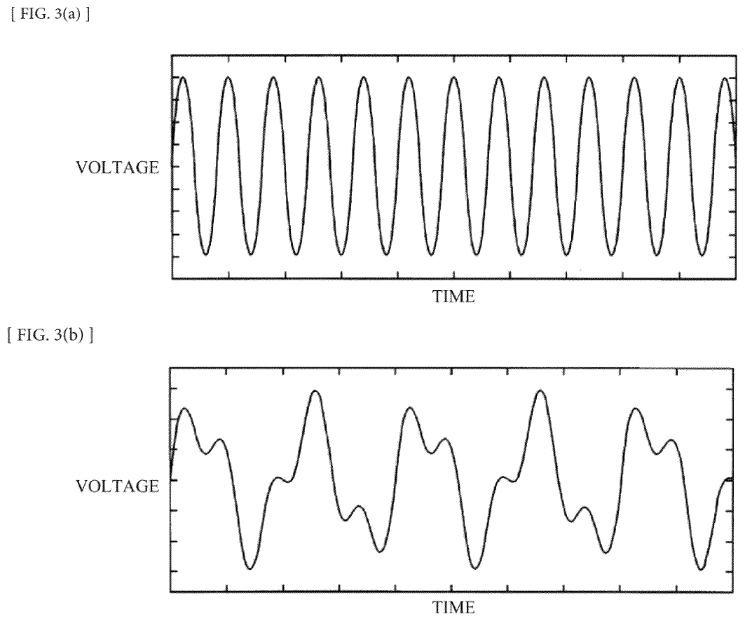

FIG. 3 is a graph schematically illustrating examples of the vibration waveform according to the first embodiment.

In FIG. 3, abscissa axes represent time, and ordinate axes represent a voltage (an amplitude).

For example, as illustrated in FIG. 3(a), the vibration waveform may be a sine wave.

Further, for example, as illustrated in FIG. 3(b), the vibration waveform may be a waveform in which multiple sine waves having different wavelengths are superimposed on (combined with) each other.

Furthermore, the vibration waveform is not limited to these waveforms and may be changed as appropriate.

For example, as the vibration waveform, various waveforms such as a square wave, a triangular wave, or a waveform simulating a traveling sound of the vehicle may be used alone or in combination with other waveforms.

In the first embodiment, a frequency of the vibration waveform may be set to have a dominant frequency in a range of, for example, 100 Hz to 400 Hz, more preferably 150 Hz to 300 Hz.

Reasons for this will be described below.

Sensory receptors that sense vibration when the air around the occupant is vibrated include, for example, Merkel's cells, Meissner's corpuscles, and Pacini's corpuscles.

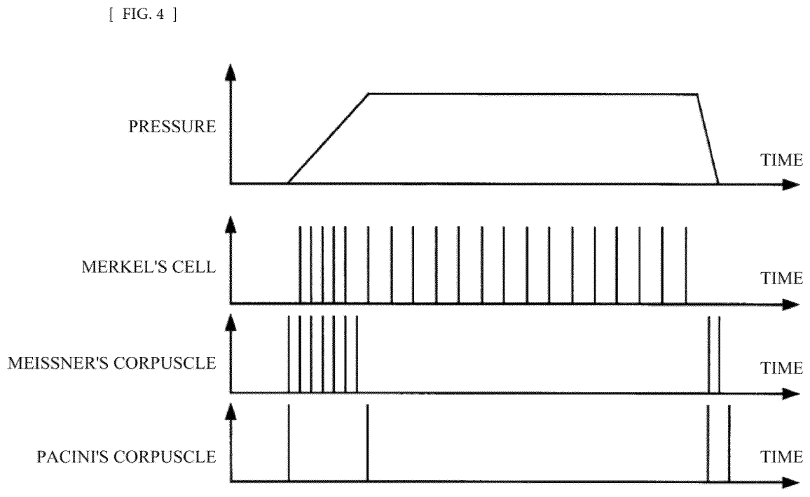

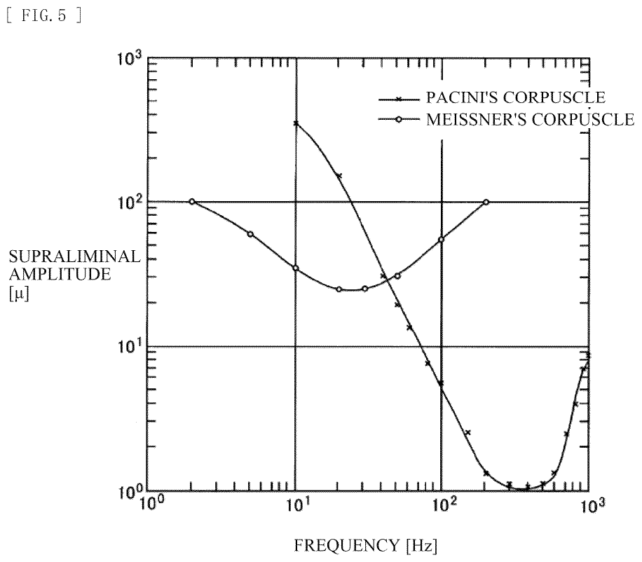

FIG. 4 is a chart schematically illustrating respective timings of electrical pulses emitted by the receptors upon receiving stimuli.

In FIG. 4, abscissa axes represent time, and ordinate axes represent a pressure, an electrical pulse generation state of the Merkel's cells, an electrical pulse generation state of the Meissner's corpuscles, and an electrical pulse generation state of the Pacini's corpuscles in order from the top.

The Merkel's cells are relatively slow in response and respond to a direct current component.

The Meissner's corpuscles respond to occurrence of a rate (a speed) of change in a contact pressure.

The Pacini's corpuscles respond to a transient change moment. The Pacini's corpuscles are considered as most sensitive of these receptors.

The sensitivity of the Pacini's corpuscles is considered as most favorable as the receptors with which the occupant perceives minute vibration as auditory and tactile composite information.

FIG. 5 is a diagram illustrating respective distributions of sensitivity to a frequency of the Pacini's corpuscles and the Meissner's corpuscles.

In FIG. 5, an abscissa axis represents the frequency, and an ordinate axis represents a supraliminal amplitude. A smaller value of the supraliminal amplitude represents higher sensitivity.

As illustrated in FIG. 5, the Pacini's corpuscles exhibit favorable sensitivity in a region of about 100 Hz to about 400 Hz, particularly more favorable sensitivity in a region of 150 Hz to 300 Hz.

These regions are included in a range of 20 Hz to 20 kHz that is typically considered as a human audible range.

The dominant frequency of the vibration waveform may be set to 250 Hz, for example.

The differential calculator 120 acquires information on the steering angle θ of the wheels W detected by the steering angle sensor 71 from the electric power steering control unit 90, and calculates a differential value Δθ differentiated by time.

The differential calculator 120 successively communicates the calculated differential value Δθ to the first gain adjuster 130.

The first gain adjuster 130 performs first gain adjustment to be described below on a fundamental wave of the vibration waveform generated by the waveform generator 110.

The first gain adjustment is performed to change a gain G1 that is an output gain by which the voltage of the vibration waveform is to be multiplied, depending on the differential value (a change rate per hour) of the steering angle θ (a parameter that correlates with a steering amount) of the steering device.

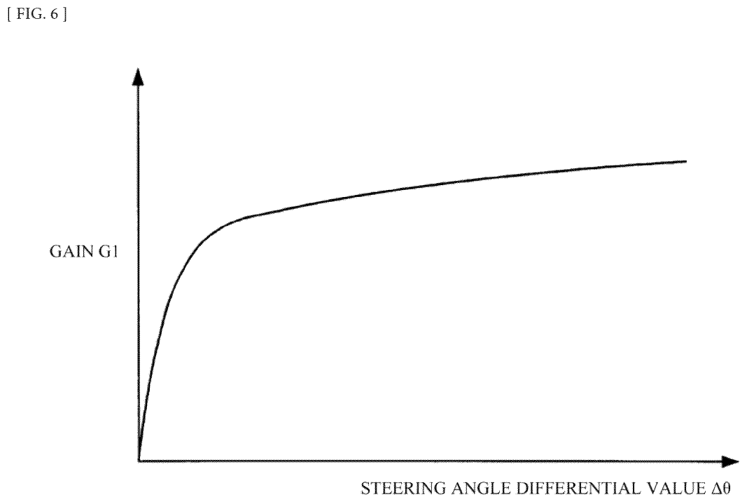

FIG. 6 is a graph schematically illustrating an example of the gain adjustment performed by the first gain adjuster.

In FIG. 6, an abscissa axis represents an absolute value of the differential value Δθ of the steering angle θ of wheels FW, and an ordinate axis represents the gain G1 by which the voltage of the vibration waveform is to be multiplied.

The gain G1 may be configured to increase in accordance with an increase in the absolute value of the differential value Δθ.

Further, the first gain adjuster 130 may be configured to maximize an increase rate of the gain G1 relative to the increase in the absolute value of the differential value Δθ in a region where the absolute value of the differential value Δθ is minute, and decrease the increase rate in accordance with the increase in the absolute value of the differential value Δθ.

The gain G1 by the first gain adjuster 130 may be calculated, for example, based on the absolute value of the differential value Δθ of the steering angle θ using a logarithmic function.

The gain G1 is expressed by, for example, Expression 1 below.

Gain G1=log(absolute value of steering angle differential value Δθ×coefficient k) (Expression 1)

The coefficient k may be a value that is set, for example, at a development stage of the vehicle, in accordance with characteristics (such as a yaw gain relative to the steering angle θ or a barycentric position) of the vehicle.

The microphone 140 is a sound collection device that is provided in the vehicle compartment and collects background noise in the vehicle compartment.

The microphone 140 is preferably disposed at a position close to the ear of the occupant, and may be provided on, for example, a headrest of a seat.

An output of the microphone 140 is communicated to the sensing value calculator 150.

The sensing value calculator 150 extracts a component of a predetermined frequency band from the background noise of the vehicle acquired by the microphone 140, and communicates a sound pressure of the extracted component as a sensing value to the second gain adjuster 160.

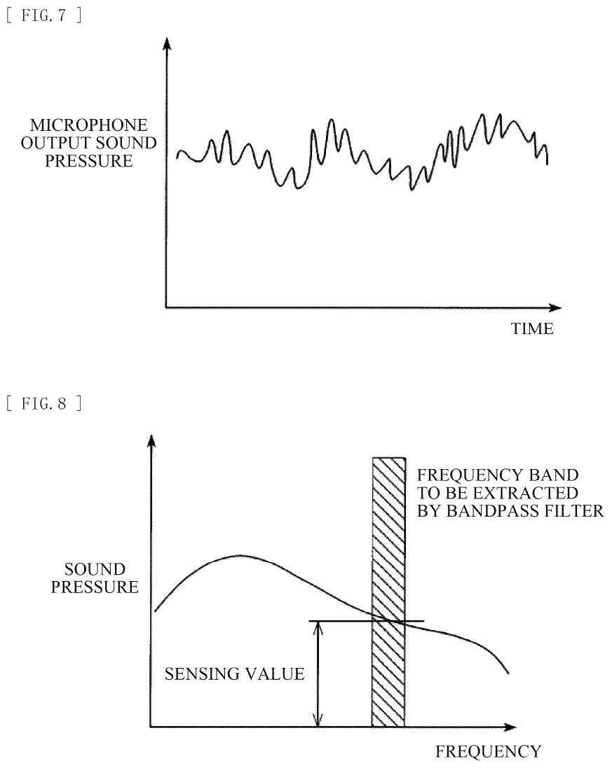

FIG. 7 is a graph schematically illustrating an example of an output history of the microphone.

In FIG. 7, an abscissa axis represents time, and an ordinate axis represents the sound pressure of the background noise acquired by the microphone 140.

The sensing value calculator 150 performs fast Fourier transform (FFT) processing on an acoustic signal of the background noise acquired by the microphone 140 to thereby convert the resultant acoustic signal into a frequency domain, and further performs bandpass filter processing on the frequency domain to thereby extract a component in a predetermined frequency band.

The frequency band to be extracted is set to include the dominant frequency of the vibration waveform to be outputted by the waveform generator 110.

The sensing value calculator 150 sets an average sound pressure in the extracted frequency band to the sensing value to be used for second gain adjustment.

FIG. 8 is a graph illustrating an example of a correlation between the sound pressure and the frequency of the background noise.

In FIG. 8, an abscissa axis represents the frequency, and an ordinate axis represents the sound pressure.

The bandpass filter may be configured to extract, for example, the frequency band adjacent to the dominant frequency (for example, 250 Hz) of the vibration waveform of the waveform generator 110.

The sound pressure in the extracted frequency band (for example, an average value in the frequency band) is provided as the sensing value to the second gain adjuster 160.

The second gain adjuster 160 further performs the second gain adjustment to be described below on the vibration waveform having been subjected to the first gain adjustment.

The second gain adjustment is performed to change the gain of the vibration waveform in accordance with the sensing value of the vehicle compartment internal noise to regulate an output amplitude of the vibration waveform in accordance with a change in the background noise (such as drivetrain noise, aerodynamic noise, or road noise) in traveling of the vehicle.

The second gain adjuster 160 performs the second gain adjustment, based on an output of the sensing value calculator 150.

The second gain adjuster 160 sets the gain G2, based on the sensing value outputted by the sensing value calculator 150.

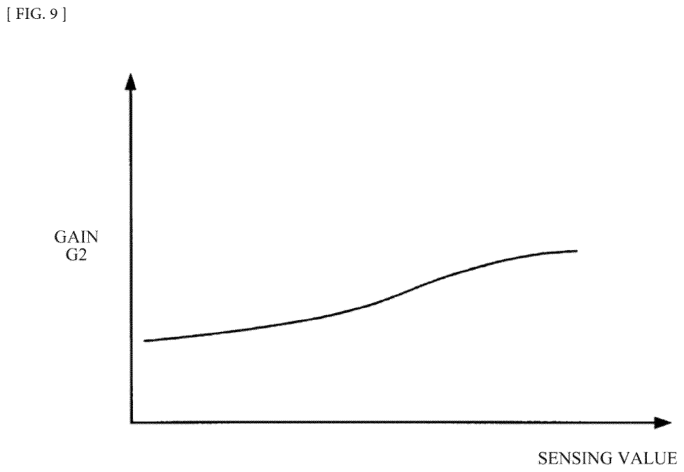

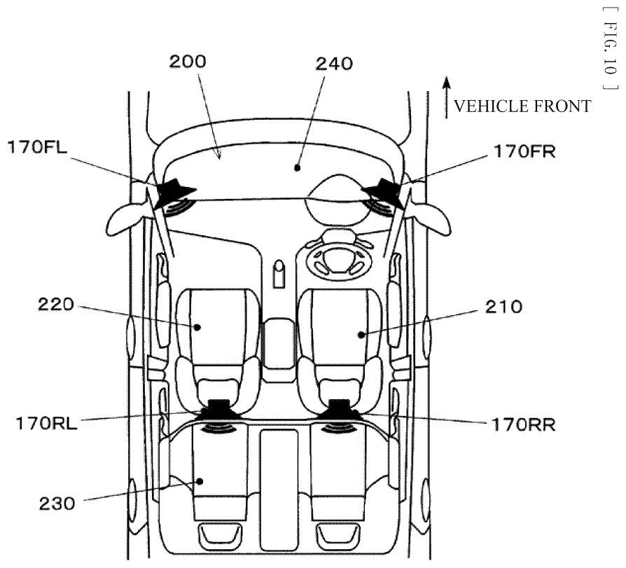

FIG. 9 is a graph schematically illustrating an example of the gain adjustment performed by the second gain adjuster.

In FIG. 9, an abscissa axis represents the sensing value, and an ordinate axis represents the gain G2 by which the voltage of the vibration waveform is to be multiplied.

The gain G2 may be configured to increase in accordance with an increase in the sensing value.

The gain G2 is set to cause a sound pressure of audio of a vibration amplitude outputted from the speaker 170 not to become dominant over the sound pressure of the background noise near the ear of the occupant.

Preferably, the gain G2 may be set to cause the audio of the vibration amplitude to be hidden in the background noise of the vehicle and have a sound pressure level subconsciously audible by the occupant.

An output value (a voltage) A of the vibration waveform having been subjected to the first gain adjustment and the second gain adjustment described above is expressed by Expression 2 below.

Output value A=output value of waveform generator×gain G1×gain G2=output value of waveform generator×log (absolute value of steering angle differential value Δθ×coefficient k)×gain G2 (Expression 2)

The speaker 170 is a vibration device that is disposed in the vehicle compartment and vibrates the air around the occupant in the vehicle compartment to thereby generate audio, based on the output value A.

Arrangement of the speaker 170 will be described below in detail.

The speaker 170 may be configured to serve also as a speaker to be used for audio reproduction or the like by an in-vehicle audio device, for example.

Further, a speaker 170 dedicated to the information communication device 100 may be provided.

FIG. 10 is a diagram schematically illustrating arrangement inside the vehicle compartment of the vehicle provided with the information communication device according to the first embodiment.

The inside of the vehicle compartment 200 is provided with, for example, a driver's seat 210, a front passenger seat 220, a rear seat 230, and an instrument panel 240.

The driver's seat 210 and the front passenger seat 220 are each a front seat provided in the front of the vehicle compartment.

The driver's seat 210 and the front passenger seat 220 are provided side by side in the vehicle width direction.

In the example illustrated in FIG. 10, the vehicle is, for example, a so-called right-hand drive vehicle in which the driver's seat 210 is provided on the right side relative to a lateral center of the vehicle body and the front passenger seat 220 is provided on the left side relative to the lateral center of the vehicle body.

The driver's seat 210 and the front passenger seat 220 each include a cushion, a seat back, and a headrest. An occupant rests his/her buttocks and thighs on the corresponding cushion. The seat back is disposed behind a back of the corresponding occupant. The headrest is provided behind a head of the corresponding occupant.

The rear seat 230 is a bench-shaped seat disposed behind the driver's seat 210 and the front passenger seat 220.

The rear seat 230 allows, for example, two occupants to be seated side by side.

The rear seat 230 includes cushions, seat backs, and headrests. The occupants each rest his/her buttocks and thighs on the corresponding cushion. The seat backs are each disposed behind a back of the corresponding occupant. The headrests are each provided behind a head of the corresponding occupant.

The rear seat 230 includes a right seat area disposed behind the driver's seat 210 and a left seat area disposed behind the front passenger seat 220.

The instrument panel 240 is a member that is provided adjacent to a front end of the vehicle compartment 200 and houses, for example, a meter display, a ventilating/air conditioning/heating device, and an infotainment device.

The instrument panel 240 is disposed to oppose the respective occupants who are seated on the driver's seat 210 and the front passenger seat 220.

In the example illustrated in FIG. 10, for example, four respective speakers 170 are provided separately in the front and back of the vehicle compartment 200 and on the left and right of the vehicle compartment 200, for example.

Hereinafter, the speakers 170 will be described with reference numerals having letters corresponding to respective positions.

A right front speaker 170FR is disposed adjacent to a right end of the instrument panel 240.

The speaker 170FR is a directional speaker that is directed toward the head (an ear) of the occupant who is seated on the driver's seat 210.

A left front speaker 170FL is disposed adjacent to a left end of the instrument panel 240.

The speaker 170FL is a directional speaker that is directed toward the head (an ear) of the occupant who is seated on the front passenger seat 220.

A right rear speaker 170RR is disposed on the headrest of the driver's seat 210.

The speaker 170RR is a directional speaker that is directed toward the head (an ear) of the occupant who is seated on the right side of the rear seat 230.

A left rear speaker 170RL is disposed on the headrest of the front passenger seat 220.

The speaker 170RL is a directional speaker that is directed toward the head (an ear) of the occupant who is seated on the left side of the rear seat 230.

The above-described configuration of the first embodiment causes audio of amplitude corresponding to the differential value Δθ of the steering angle θ to be emitted from the speaker 170 to the occupant when the driver performs the steering operation to thereby change the steering angle θ of the wheels W.

The audio is masked by the traveling sound (the background noise) of the vehicle and is thus difficult to consciously recognize by the occupant as a sound, but allows the occupant to subconsciously predict the occurrence of the behavior of the vehicle involving generation of a lateral acceleration rate and a yaw rate.

According to the first embodiment described above, the following effects are obtainable.
(1) Audio is generated of which the sound pressure is increased in accordance with the increase in the absolute value of the differential value Δθ of the steering angle θ of the wheels W generated by the steering device. Such audio allows the occupant to predict the occurrence of the behavior on an initial steering phase prior to actual generation of, for example, the lateral acceleration rate, the yaw rate, and a roll angle on the vehicle.

This configuration makes it possible to improve predictability of the occupant for the behavior of the vehicle and prevent the occupant from feeling that the behavior of the vehicle is abrupt.

This allows the occupant to prepare for the generation of, for example, the lateral acceleration rate by tightening his/her body, for example. This prevents, for example, unintentional loss of a sitting posture.
(2) The vibration waveform has the dominant frequency included in a frequency band of 100 Hz to 400 Hz, more preferably 150 Hz to 300 Hz. This configuration enables use of, for example, the Pacini's corpuscles that are highly sensitive in the audible range and a skin sensation, allowing the occupant to favorably sense the sound through acoustics and recognize the skin sensation. This makes it possible to communicate the information to the occupant more reliably.
(3) The gain G1 is set based on the absolute value of the differential value Δθ of the steering angle θ using the logarithmic function. This configuration enables a large gain G1 to be set even in a region where the absolute value of the differential value Δθ is relatively small. This makes it possible to communicate the information to the occupant appropriately even on the initial steering phase where the steering angle θ and the differential value (a steering speed) Δθ are each minute.

The configuration further allows for preventing the output gain from becoming excessively large in a region where the absolute value of the differential value Δθ is large.
(4) The gain G2 is set to allow the sound pressure generated by the vibration caused by the speaker 170 not to become dominant over the background noise near an ear of at least one occupant in traveling of the vehicle. This configuration allows the audio generated by the vibration caused by the speaker 170 to be covered by the background noise of the vehicle. This makes it possible to prevent the occupant from feeling that the audio is unpleasant to the ear and communicate the information to the occupant appropriately.
(5) The steering angle θ of the wheels W is used as the parameter that correlates with the steering amount of the steering device. This configuration enables easy and appropriate acquisition of the parameter using the steering angle sensor typically provided in any general vehicle.

### Second Embodiment

Next, an information communication device according to a second embodiment of the invention will be described.

In the second embodiment, the vehicle includes an automated driving function that performs, for example, a steering operation, an acceleration operation, and a deceleration operation autonomously without relying on a driving operation performed by the driver.

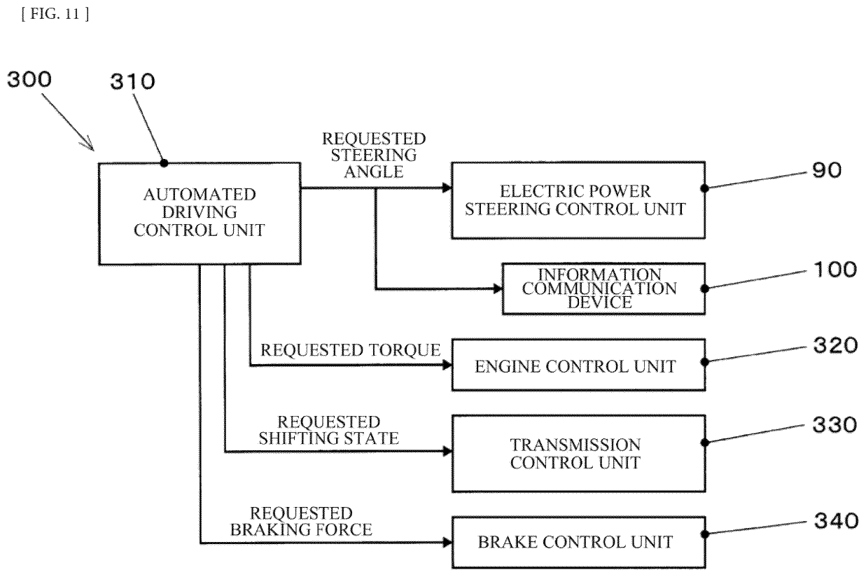

FIG. 11 is a diagram schematically illustrating a configuration of an automated driving system of the vehicle provided with the information communication device according to the second embodiment.

An automated driving system 300 further includes, for example, an automated driving control unit 310, an engine control unit 320, a transmission control unit 330, and a brake control unit 340, in addition to the electric power steering control unit 90 described above.

These units each include a microcontroller including, for example, an information processor such as a CPU, a storage such as a RAM or a ROM, an input/output interface, and a bus that couples these components to each other.

Further, these units are configured to be coupled to each other directly or via the in-vehicle LAN such as the CAN communication system to thereby communicate with each other.

The automated driving control unit 310 recognizes an environment around the own vehicle using, for example, a high-precision 3D map or various sensors such as a stereo camera device, a millimeter wave radar device, or a laser scanner device.

The automated driving control unit 310 generates, based on the recognized environment, an automated driving scenario including information on, for example, a traveling line and a speed of the own vehicle.

The automated driving control unit 310 provides, based on the automated driving scenario, instructions to the electric power steering control unit 90, the engine control unit 320, the transmission control unit 330, and the brake control unit 340, to thereby control steering, acceleration, and deceleration of the vehicle.

The electric power steering control unit 90 controls the actuator unit 80 in accordance with a requested steering angle specified by the automated driving control unit 310 instead of a steering input from the driver as in the first embodiment to thereby steer the wheels W.

The engine control unit 320 comprehensively controls an engine serving as a power source for traveling the vehicle and auxiliary devices of the engine.

The engine control unit 320 controls an output of the engine to cause torque actually generated by the engine to become equal to requested torque specified by the automated driving control unit 310.

The transmission control unit 330 comprehensively controls a transmission that shifts (decelerates or accelerates) rotation of an output shaft of the engine and auxiliary devices of the transmission.

In accordance with the instruction from the automated driving control unit 310, the transmission control unit 330 performs, for example, switching between a drive range and a non-drive range, switching between forward traveling and rearward traveling, and shifting (changing a speed ratio) in the forward traveling.

The brake control unit 340 controls a braking force of a hydraulic service brake provided in each of the wheels of the vehicle.

The brake control unit 340 regulates a brake fluid pressure to be supplied to respective wheel cylinders of the wheels in accordance with a requested braking force specified by the automated driving control unit 310 to thereby generate a necessary braking force.

In the second embodiment, even when the automated driving is performed in which the driver basically does not perform the steering operation, the requested steering angle communicated from the automated driving control unit 310 to the electric power steering control unit 90 is set to an input (the parameter that correlates with the steering angle of the steering device) into the information communication device 100, and the first gain adjustment is performed based on a differential value of the input.

According to the second embodiment described above, even in the vehicle performing the automated driving, audio is generated in accordance with the absolute value of the differential value of the steering angle at the time of starting the steering under the automated driving control. Such a configuration allows the occupant to predict the occurrence of the behavior of the vehicle involving the generation of, for example, the lateral acceleration rate, the yaw rate, and the roll angle. This makes it possible to prevent the occupant from feeling that the behavior of the vehicle is abrupt.

### MODIFICATION EXAMPLES

The invention is not limited to the above-described embodiments, and various modifications and changes are possible. Such modifications and changes fall within the technical scope of the invention as well.
(1) The configurations of the information communication device and the vehicle are not limited to the above-described embodiments, and may be changed as appropriate.

For example, a hardware configuration of the information communication device and a specific method of the gain adjustment of the vibration waveform are not limited to the configuration of each of the embodiments, and may be changed as appropriate.
(2) In each of the embodiments, for example, the steering angle (the actual steering angle detected by the steering angle sensor or the requested steering angle in the automated driving control) is used as the parameter that correlates with the steering amount of the steering device; however, the parameter is not limited to this parameter and may be changed appropriate.

The parameter may include one or more of, for example, steering torque (input torque) to be inputted by the driver, an operation amount of an actuator that steers the wheels (for example, a rotation amount of the motor), and an output instruction value to be received by the actuator.
(3) The invention may be applied not only to a vehicle in which an operation member such as a steering wheel is mechanically coupled to a steering mechanism such as a steering gearbox as in each of the embodiments, but also to a vehicle including a steer-by-wire steering device in which, for example, the steering wheel is not mechanically coupled to the steering mechanism. In this case, the actual steering angle of the front wheels and a state of the steering mechanism (for example, the rotational angle position of the pinion gear and a movement amount of the rack shaft) may be used as the parameter that correlates with the steering amount of the steering device.
(4) In each of the embodiments, for example, the level of the background noise of the vehicle is acquired by the microphone; however, the invention is not limited thereto and the level of the background noise may be acquired by any other method. For example, the level of the background noise may be estimated based on an acceleration rate of an unsprung part of the vehicle that correlates with an input from a road surface or an output value (torsion bar torque) of the torque sensor of the steering device.

An aspect of the invention provides an information communication device configured to be provided in a vehicle. The vehicle includes a steering device configured to steer a wheel of the vehicle. The information communication device is characterized by including a parameter detector, a vibration waveform generator, a vibrator, and a gain adjuster. The parameter detector is configured to detect a parameter that correlates with a steering amount of the steering device. The vibration waveform generator is configured to generate a vibration waveform. The vibrator is configured to cause vibration of air around an occupant with the vibration waveform. The gain adjuster is configured to increase an output gain of the vibration waveform in accordance with an increase in an absolute value of a differential value of the parameter.

This configuration allows audio to be generated of which a sound pressure is increased in accordance with the increase in the absolute value of the differential value (a so-called steering speed) that correlates with the steering amount of the steering device. Such audio allows the occupant to predict occurrence of a behavior on an initial steering phase prior to actual generation of, for example, a lateral acceleration rate, a yaw rate, and a roll angle on the vehicle.

This configuration makes it possible to improve predictability of the occupant for the behavior of the vehicle and prevent the occupant from feeling that the behavior of the vehicle is abrupt.

According to the invention, the vibration waveform may have a dominant frequency included in a frequency band of 100 Hz to 400 Hz.

This configuration enables use of, for example, Pacini's corpuscles that are highly sensitive in an audible range and a skin sensation, allowing the occupant to favorably sense the sound through acoustics and recognize the skin sensation. This makes it possible to communicate information to the occupant more reliably.

More preferably, the dominant frequency is set to a frequency band of 150 Hz to 300 Hz here. This allows for use of a more favorable sensitivity region of the receptor, facilitating the above-described effects.

According to the invention, the gain adjuster may be configured to maximize an increase rate of the output gain relative to the increase in the absolute value of the differential value in a region where the absolute value of the differential value is minute, and decrease the increase rate in accordance with the increase in the absolute value of the differential value.

This configuration enables a large output gain to be set even in a region where the absolute value of the differential value is relatively small. This makes it possible to communicate the information to the occupant appropriately even on the initial steering phase where a steering angle and the steering speed are each minute.

The configuration further allows for preventing the output gain from becoming excessively large in a region where the absolute value of the differential value is large.

For example, the output gain may be set based on a logarithmic function of the absolute value of the differential value.

According to the invention, the gain adjuster may be configured to set the output gain to allow a sound pressure generated by the vibration caused by the vibrator not to become dominant over background noise near an ear of at least one of the occupant in traveling of the vehicle.

This configuration allows the audio generated by the vibration caused by the vibrator to be covered by background noise of the vehicle. This makes it possible to prevent the occupant from feeling that the audio is unpleasant to the ear and communicate the information to the occupant appropriately.

According to the invention, the parameter may include one or more of a steering angle of the steering device, input torque to be received by the steering device, an operation amount of an actuator configured to steer the wheel, and an output instruction value to be received by the actuator.

This configuration enables appropriate determination of the steering amount of the steering device of any general vehicle using the easily detectable parameter.

### DESCRIPTION OF REFERENCE NUMERALS

1 Electric power steering apparatus
W Wheel
10 Steering wheel
20 Steering shaft
21 Intermediate shaft
22 Pinion shaft
23,24 Universal joint
30 Rack shaft
31 Rack gear
40 Rack housing
41 Rack boot
50 Tie rod
51,52 Ball joint
60 Housing
71 Steering angle sensor
72 Torque sensor
80 Actuator unit
81 Motor
82 Gearbox
90 Electric power steering control unit
100 Information communication device
110 Waveform generator
120 Differential calculator
130 First gain adjuster
140 Microphone
150 Sensing value calculator
160 Second gain adjuster
170 (170FR, 170FL, 170RR, 170RL) Speaker
200 Vehicle compartment
210 Driver's seat
220 Front passenger seat
230 Rear seat
240 Instrument panel
300 Automated driving system
310 Automated driving control unit
320 Engine control unit
330 Transmission control unit
340 Brake control unit

1. An information communication device configured to be provided in a vehicle, the vehicle comprising a steering device configured to steer a wheel of the vehicle, the information communication device comprising:
a parameter detector configured to detect a parameter that correlates with a steering amount of the steering device;
a vibration waveform generator configured to generate a vibration waveform;
a vibrator configured to cause vibration of air around an occupant with the vibration waveform; and
a gain adjuster configured to increase an output gain of the vibration waveform in accordance with an increase in an absolute value of a differential value of the parameter.

2. The information communication device according to claim 1, wherein the vibration waveform comprises a dominant frequency included in a frequency band of 100 Hz to 400 Hz.

3. The information communication device according to claim 1, wherein
the gain adjuster is configured to
maximize an increase rate of the output gain relative to the increase in the absolute value of the differential value in a region where the absolute value of the differential value is minute, and
decrease the increase rate in accordance with the increase in the absolute value of the differential value.

4. The information communication device according to claim 1, wherein the gain adjuster is configured to set the output gain to allow a sound pressure generated by the vibration caused by the vibrator not to become dominant over background noise near an ear of at least one of the occupant in traveling of the vehicle.

5. The information communication device according to claim 1, wherein the parameter comprises one or more of a steering angle of the steering device, input torque to be received by the steering device, an operation amount of an actuator configured to steer the wheel, and an output instruction value to be received by the actuator.

6. The information communication device according to claim 2, wherein
the gain adjuster is configured to
maximize an increase rate of the output gain relative to the increase in the absolute value of the differential value in a region where the absolute value of the differential value is minute, and
decrease the increase rate in accordance with the increase in the absolute value of the differential value.

7. The information communication device according to claim 2, wherein the gain adjuster is configured to set the output gain to allow a sound pressure generated by the vibration caused by the vibrator not to become dominant over background noise near an ear of at least one of the occupant in traveling of the vehicle.

8. The information communication device according to claim 2, wherein the parameter comprises one or more of a steering angle of the steering device, input torque to be received by the steering device, an operation amount of an actuator configured to steer the wheel, and an output instruction value to be received by the actuator.
